(19) United States
(12) Patent Application Publication
(10) Pub. No.: US 2008/0300002 A1
(43) Pub. Date: Dec. 4, 2008

(54) Wireless transmission in noisy RF environment

(76) Inventor: Eliezer A. Sheffer, Petach Tikva (IL)

Correspondence Address: Robert G. Lev;Lev Intellectual Property Consulting, 4766 Michigan Boulevard, Youngstown, OH, 44505, US

(21) Appl. No.: 12/156,524

(22) Filed: Jun. 2, 2008

Related U.S. Application Data
(60) Provisional application No. 60/924,854, filed on Jun. 1, 2007.

(51) Int. Cl. H04Q 7/20; G08C 17/00; H04B 7/00

(52) U.S. Cl. 455/509; 375/220; 455/517

(57) ABSTRACT

A method of wireless transmission by a base unit, including repeating for a plurality of transmission cycles the acts of scanning a plurality of frequencies to determine frequencies having low noise levels, by the base unit, selecting, by the base unit, uplink channels, responsive to the determined frequencies having low noise levels, transmitting to subscriber units, by the base unit, a message indicating the selected uplink channels and tuning the base unit to receive uplink messages on the selected uplink channels.

### PRIORITY INFORMATION

The present invention claims priority to Provisional Patent Application number 60/924,854, filed on Jun. 01, 2007.

### FIELD OF THE INVENTION

The present invention relates to communication systems and in particular to signal transmission in high noise environments.

### BACKGROUND OF THE INVENTION

With the wide spread deployment of cellular and satellite communication systems many novel services utilizing wireless communications, beyond the conventional voice, SMS and data services, have been suggested. Such services include, among others, traffic reports, security alerts and parking services. However, these new services require large bandwidth capacities unavailable or uneconomical to justify in existing cellular networks, making many of the possible services uneconomical or simply impossible.

U.S. Pat. No. 5,884,184 to Sheffer, titled: “Supervised cellular reporting network”, the disclosure of which is incorporated herein by reference, describes some such services.

The available spectrum is generally partitioned by governments to different bands which are allocated for different uses. Most frequency bands are licensed by the government to communication service providers at substantial prices. Other frequency bands are allocated for free unlicensed utilization.

One of the major problems which challenge providers of communication services is the noise levels of wireless environments. The licensed frequency bands have a low noise floor, but are saddled with other interference sources such as Common Channel Interference (CCI), Adjacent Channel Interference (ACI) and inter-modulation interferences (Intermod). Non-licensed channels have even worse noise conditions and are used only for short distances. Sometimes, channels are so noisy, due to environmental and other sources of noise, that the channels simply cannot serve their task.

U.S. Pat. No. 6,353,628 to Wallace et al., titled: “Apparatus, method and system having reduced power consumption in a multi-carrier wireline environment”, the disclosure of which is incorporated herein by reference in its entirety, suggests avoiding poor spectral regions, due to interference such as noise and inter-modulation, by modems associated with a transmitter and a receiver negotiating for best sub-channel carriers during training and rejecting those sub-channel carriers that have a performance below a predetermined and acceptable threshold.

In some environments, however, such solutions are insufficient, as the noise on each of the sub-channel carriers varies dynamically.

US patent publication 2002/0041622 to Steed et al., titled: “Spread spectrum frequency hopping communications system”, the disclosure of which is incorporated herein by reference, suggests using a frequency hopping scheme which switches between frequencies when the noise level on a currently utilized frequency is too high.

The suggestions of this publication, however, are believed to be unsuitable for highly noisy environments and/or when transmissions without acknowledgements are desired.

### SUMMARY OF THE INVENTION

An aspect of some embodiments of the present invention relates to a transmission method which involves repeatedly performing transmission sub-cycles including a first phase of assessing the noise level on a plurality of frequencies and accordingly selecting transmission channels, and a second phase in which the selected channels are used for data transmission. Actively assessing frequencies before problems are encountered due to high noise levels, provides low loss rates due to noise. This has many advantages, such as avoiding channel jamming, avoiding eavesdropping and facilitating transmissions without acknowledgements.

In various embodiments of the invention, the assessing of the noise level is performed at least every five minutes, at least every minute or even at least every ten seconds. Optionally, the assessing is performed at least every five seconds. In some embodiments of the invention, the sub-cycle rate is selected according to statistics of the rate of change of the noise level in the area of the transmissions.

Optionally, the transmission method is carried out in a server-client transmission configuration. In some embodiments of the invention, the channel assessment is performed by the server skipping through a plurality of frequencies, with the client following the same skipping steps. Optionally, the server performs at least some random movements between frequencies, but notifies the client in advance so that it can keep track of the steps of the server. Using random frequency steps in the scanning, resulting in at least partially random channel selection, hinders unwelcome monitoring (eavesdropping).

In some embodiments of the invention, the transmission method is carried out in a cellular type configuration, including a plurality of server base units, each of which services subscriber units in its vicinity. A central controller optionally coordinates the selection of frequencies between the server base units, to prevent interference therebetween. The plurality of frequencies may be selected from a licensed or non-licensed band.

An aspect of some embodiments of the invention relates to managing a cellular transmission network on an unlicensed frequency band. The cellular transmission network includes a plurality of base stations, optionally more than 10, more than 100 or even more than 1000, which provide communication coverage over a relatively large area. In some embodiments of the invention, the base stations provide communication services to mobile units which may move between base stations.

The base stations participate in selection of low noise channels in the frequency band, so that the communications are managed at least at a reasonable quality. Using unlicensed bandwidth allows providing communication services at a relatively low cost.

An aspect of some embodiments of the invention relates to a transmission method involving stepping between frequencies which are selected entirely randomly, without dependence on previously selected frequencies. Using randomly selected frequencies makes eavesdropping harder than when frequency stepping in accordance with a semi-random sequence or and other frequency sequence.

An aspect of some embodiments of the invention relates to managing a cellular network in which the frequencies used by the base units of the network are adjusted dynamically. Optionally, the dynamic adjustment is performed by a central controller which receives information from the base units and provides them with frequency allocations. In some embodiments of the invention, the central controller receives information on noise levels on different frequency bands from various base units and dynamically allocates the frequencies accordingly.

There is therefore provided in accordance with an exemplary embodiment of the invention, a method of wireless transmission by a base unit, comprising

(I) scanning a plurality of frequencies to determine frequencies having low noise levels, by the base unit;

(II) selecting, by the base unit, uplink channels, responsive to the determined frequencies having low noise levels;

(III) transmitting to subscriber units, by the base unit, a message indicating the selected uplink channels;

(IV) tuning the base unit to receive uplink messages on the selected uplink channels; and

(V) repeating (I)-(IV) for a plurality of transmission cycles.

Optionally, scanning the plurality of frequencies comprises scanning a group of frequencies including at least one frequency selected randomly. Optionally, scanning the plurality of frequencies comprises sequentially scanning frequencies at predetermined intervals until a frequency with a low noise level is identified and skipping to a randomly selected frequency when a frequency with a low noise level is identified.

Optionally, scanning the plurality of frequencies comprises scanning until a predetermined number of low noise frequencies are identified. Optionally, selecting the uplink channels is performed at least partially responsive to instructions from a central controller. Optionally, selecting the uplink channels comprises selecting a predetermined number of lowest noise frequencies. Optionally, selecting the uplink channels comprises selecting a predetermined number of frequencies having a noise level below a predetermined threshold. Optionally, the method includes identifying during the scanning candidate frequencies and transmitting a message on at least one of the candidate frequencies during the scanning.

Optionally, the transmitted message includes an indication of a next frequency to be scanned. Optionally, the repeating is performed at a configured period cycle and wherein the tuning to receive uplink messages occupies less than 80% of the period of the cycle. Optionally, the repeating is performed at least every five minutes or even at least every minute. Optionally, scanning the plurality of frequencies comprises scanning frequencies in a non-licensed frequency band.

There is further provided in accordance with an exemplary embodiment of the invention, a method of wireless transmission by a subscriber unit, comprising:

(I) scanning a plurality of frequencies to determine their noise levels, by a subscriber unit;

(II) selecting a frequency with a low noise level for receiving transmissions;

(III) transmitting a message indicating the selected frequency, from the subscriber unit to a base unit;

(IV) tuning onto the selected frequency to receive messages transmitted from the base unit; and

(V) repeating (I)-(IV) for a plurality of transmission cycles every hour.

Optionally, scanning the plurality of frequencies comprises skipping between at least some of the frequencies by a predetermined frequency jump. Optionally, scanning the plurality of frequencies comprises skipping to at least one of the scanned frequencies according to an instruction received from the base station. Optionally, selecting the frequency comprises receiving a message from the base unit indicating frequencies for uplink transmissions to the base unit and selecting a frequency not included in the frequencies for uplink transmission, for receiving transmissions. Optionally, transmitting the message indicating the selected frequency on one of the frequencies fro uplink transmission. Optionally, repeating (I)-(IV) for a plurality of transmission cycles every hour comprises repeating (I)-(IV) at least every two minutes or even at least every 30 seconds. Optionally, the method includes transmitting a still-alive message from the subscriber unit to the base station at least every two minutes.

There is further provided in accordance with an exemplary embodiment of the invention, a method of allocating frequencies in a base station network, comprising receiving lists of low noise frequencies, by a central controller, from a plurality of base stations, assigning frequencies to be used by each of the base stations by the central controller, responsive to the received lists, in a manner which minimizes interference between the base stations and repeating the receiving of lists and assigning of frequencies at least every 10 minutes. Optionally, repeating the receiving of lists and assigning of frequencies is performed at least every minute.

There is further provided in accordance with an exemplary embodiment of the invention, a base unit, comprising a plurality of transceivers; and a controller configured to periodically, a plurality of times an hour, scan a plurality of frequencies to determine their noise levels, select responsive to the scanning a plurality of frequencies for uplink transmissions, transmit a message listing the selected frequencies through one of the transceivers and set for each of the selected frequencies one of the transceivers to receive messages on the selected frequency, until a next scan is performed.

Optionally, the controller is configured to randomly select at least two of the frequencies scanned. Optionally, the controller is configured to select at least two of the frequencies scanned by progressing a predetermined frequency step from a previously scanned frequency.

There is further provided in accordance with an exemplary embodiment of the invention, a method of wireless transmission, comprising providing a plurality of base stations configured to service subscriber units in their vicinity, configuring the base stations to communicate with the subscriber units over an unlicensed frequency band, receiving communications from subscriber units by the plurality of base stations over the unlicensed frequency band; and transferring the received communication by the plurality of base stations to a central unit.

Optionally, the base stations are configured to periodically select specific low frequencies within the band on which the communications are received. Optionally, the plurality of base stations include at least 50 base stations. Optionally, providing the base stations comprises providing at least one base station having an antenna longer than 100 meters.

There is further provided in accordance with an exemplary embodiment of the invention, a method of wireless transmission, comprising:
(I) selecting one or more frequencies, at least partially randomly;
(II) transmitting a list of the selected frequencies;
(III) receiving transmissions on the one or more selected frequencies; and
(IV) repeating (I)-(III) at least every five minutes.

Optionally, selecting the one or more frequencies comprises scanning a plurality of frequencies and selecting frequencies having a low noise level. Optionally, scanning a plurality of frequencies comprises scanning a plurality of frequencies at predetermined frequency steps from each other until a low noise frequency is found and then skipping to a randomly selected frequency. Optionally, transmitting the list of the selected frequencies comprises transmitting on a frequency determined to have low noise level.

### BRIEF DESCRIPTION OF FIGURES

Non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a communication network, in accordance with an embodiment of the invention;

FIG. 2 is a timeline of the operation of a communication network, in accordance with an embodiment of the invention;

FIG. 3 is a flowchart of acts performed during a channel assessment period, in accordance with an embodiment of the invention; and

FIG. 4 is a flowchart of acts performed in downlink channel allocation, in accordance with an exemplary embodiment of the invention.

### DETAILED DESCRIPTION OF EMBODIMENTS

### Hardware

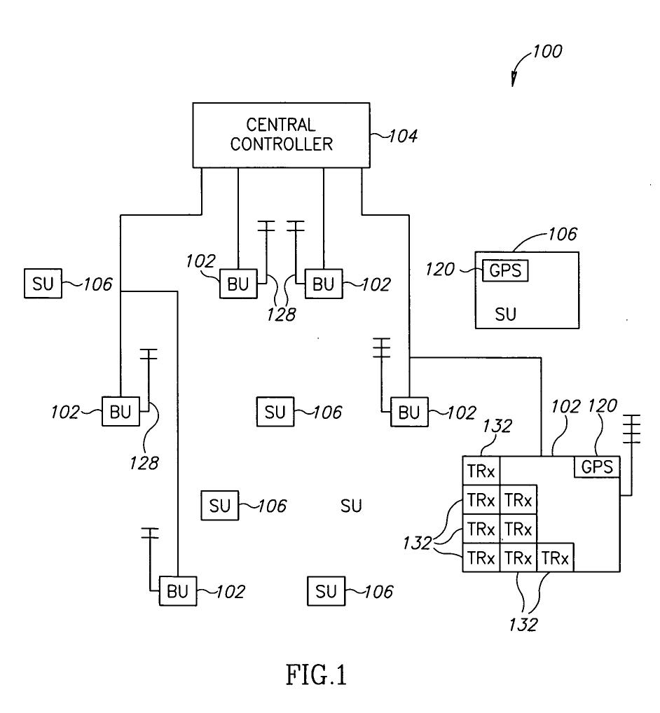

FIG. 1 is a schematic illustration of a communication network 100, in accordance with an embodiment of the invention. Network 100 includes a plurality of base units, henceforth BUs 102, spread out over a desired area, so as to provide communication coverage thereover. A central controller 104 communicates with the BUs 102, receives information therefrom and provides operation instructions thereto. In addition, central controller 104 optionally serves as a gateway between network 100 and other networks. The communications between central controller 104 and BUs 102 may use substantially any communication medium known in the art, including copper wireline, fiber optics and wireless mediums. Optionally, the communications between central controller 104 and BUs 102 is over a virtual private network (VPN) using an IP packet protocol, although other types of transmission networks may be used. In some embodiments of the invention, when network 100 is very large, some of the tasks of central controller 104 are performed by a plurality of regional controllers. Furthermore, it will be appreciated that the functionality of central controller 104 may be distributed over a plurality of nodes.

Subscriber units (SUs) 106, which may be mobile or stationary, wirelessly communicate with BUs 102. Network 100 is optionally primarily designed for low bandwidth transmissions from SUs 106 to BUs 102. The transmissions may include, for example, short messages, surveillance notifications and keep alive messages.

In some embodiments of the invention, each of subscriber units 106 comprises a global positioning system (GPS) receiver 120, which provides synchronized time signals to all of BUs 102 and SUs 106. Alternatively, any other method known in the art is used for achieving time synchronization, such as transmission of periodic timing signals by BUs 102. Each BU 102 optionally includes a GPS receiver 120 and a plurality of transceivers 132, optionally one for downlink transmissions and several (e.g., more than 5, more than 7) for uplink transmissions. Alternatively, to reduce hardware costs, instead of transceivers 132, BUs 102 include a single transmitter and a plurality of receivers.

BUs 102 may be employed in fixed locations or may be mobile to allow easy adjustment of the layout of BUs 102 to changing conditions. In some embodiments of the invention, a relatively tall antenna 128 is used, which may be longer than 100 meters, than 200 meters, or even 300 meters or larger. Optionally, some or all of SUs 102 transmit at an Equivalent isotropically radiated power (EIRP) level above 0.6 Watts, above 0.8 Watts or even 1 Watt or more. Using such antenna sizes and/or SU power levels, BUs 102 optionally communicate with SUs 106 in a radius of at least 6 kilometers, at least 10 kilometers or even at least 15 kilometers. In some embodiments of the invention, in areas with a low density of SUs 106, BUs 102 are spread out with a density of less than one BU 102 for every 200 square miles or even less than one BU 102 for every 280 square miles.

### Operation Overview

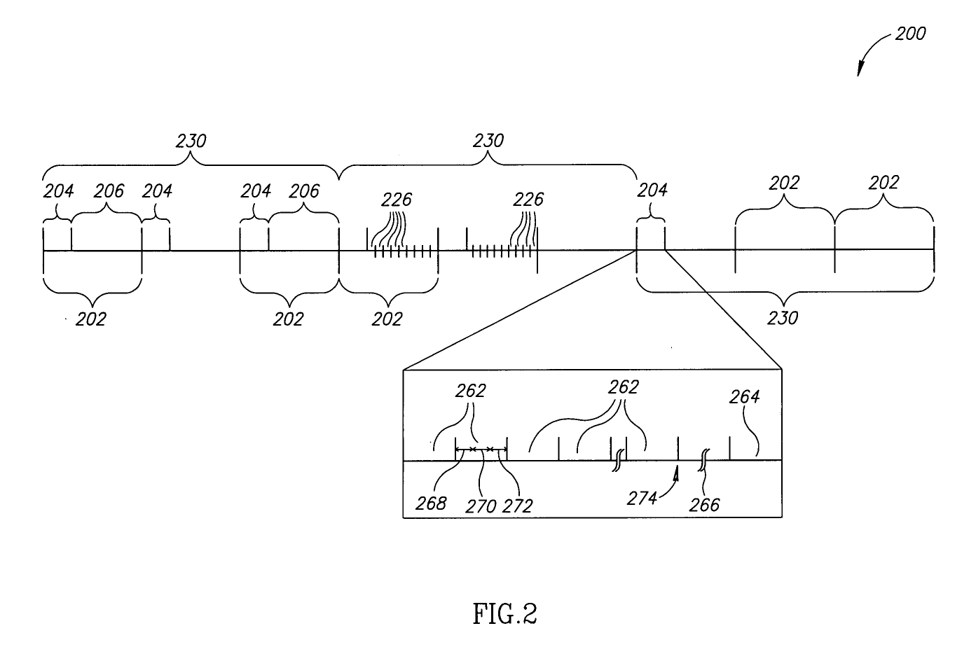

FIG. 2 is a timeline 200 of the operation of network 100, in accordance with an embodiment of the invention. Timeline 200 is divided into a sequence of sub-cycles 202, which are formed of a channel assessment period 204 and a transmission period 206. During the channel assessment period 204, BU 102 reviews a plurality of frequencies within the band assigned thereto, to determine their noise level and hence their suitability for carrying transmissions. According to their assessments of the various frequencies, BU 102 optionally selects one channel to be used for downlink transmissions from BU 102 to the SUs 106 and a plurality of uplink channels for uplink transmissions. During the channel assessment period 204, BU 102 notifies SUs 106 as to which channels were selected. Thereafter, in the transmission period 206, BU 102 sets its receivers 134 to the selected uplink channels and listens to transmissions from SUs 106. The selected downlink channel is used during transmission period 206 for transmissions from BU 102 to SUs 106.

As discussed hereinbelow, for some applications using network 100, transmission cycles 230 are defined, for allocation of slots 226 of transmission period 202 to the SUs 106. As shown, each cycle 230 includes three sub-cycles 202. It is noted, however, that cycles 230 may include fewer sub-cycles 202, possibly only a single sub-cycle 202, or may include more sub-cycles 202, for example more than five or even more than 10 sub-cycles 202.

The uplink transmissions are optionally provided by BU 102 to central controller 104, which processes them and/or forwards them to their destination.

In some embodiments of the invention, channel assessment period 204 is between about 3-5 seconds. The length of sub-cycle 202 is optionally selected according to the time in which the noise level is expected to be stable and is optionally greater than 30 seconds or even greater than or equal 60 seconds. Thus, the overhead of channel assessment period 204 is less than 20%, optionally even less than 10% or 5%. It is noted, however, that in some embodiments of the invention, in noisy environments, channel assessment periods 204 are carried out less than every 30 seconds, less than every 20 seconds or even not more than every 10 seconds. The resultant overhead being greater than 20%, or even greater than 40% is considered worthwhile, in these embodiments, as otherwise the channel could not be used at all.

### Configuration

At a configuration stage, BUs 102 and SUs 106 are configured (300) with a frequency band which they are to use for communication. In some embodiments of the invention, all the BUs 102 use a same frequency band. Alternatively, different BUs 102 are configured to use different sub-bands of a general frequency band of network 100. Optionally, in accordance with this alternative, all the BUs 102 use a same specific beginning frequency band on to which the SUs 106 tune at the beginning of each channel assessment period 204, but the different BUs 102 may have different frequency bands as the remaining portions of their frequency band.

In some embodiments of the invention, BUs 102 and SUs 106 are configured with a continuous range of a frequency band which can be defined, for example, by its upper and lower limits. Alternatively, BUs 102 and SUs 106 are configured to operate on a plurality of disjoint frequency bands, according to the available frequencies in the region or country of deployment. Further alternatively or additionally, BUs 102 and SUs 106 are configured with a list of discrete frequencies. Optionally, the configured frequency band is selected in accordance with government regulations, such as from the frequency bands defined for non-licensed use. In the US, for example, the frequency band between 902-928 MHz may be used, while in Europe, a band in the 800 MHz may be convenient.

The configuration optionally also defines the size of sub-cycles 202 and a default frequency step size used during channel assessment. The configuration optionally also defines application specific parameters, such as how often each SU 106 is allowed and/or required to transmit signals to the BU 102.

### Assessment Period

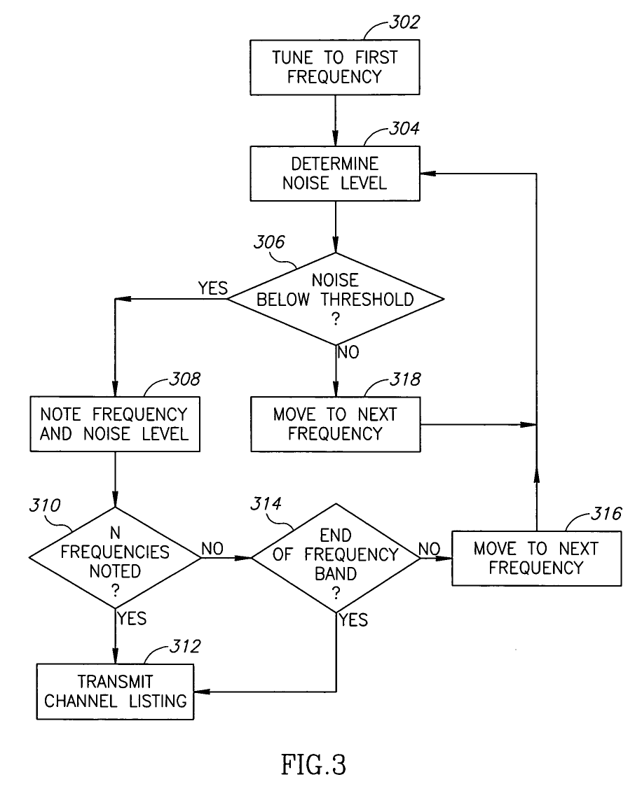

FIG. 3 is a flowchart of acts performed during channel assessment period 204, in accordance with an embodiment of the invention. At the beginning of each channel assessment period 204, the BUs 102 tune (302) onto a first frequency of the configured frequency band. BUs 102 listen to the signals on the frequency and determine (304) the noise level, for example, the Received Signal Strength Indication (RSSI), of the frequency. If (306) the noise level is below a predetermined threshold, the frequency and noise level are noted (308). If (310) a predetermined number N of frequencies were noted, BU 102 transmits (312) a message listing the candidate uplink and downlink channels to be used in the subsequent transmission period 206, to the SUs 106 in its vicinity, and the transmission period begins. If, however, the predetermined number of frequencies were not yet noted (310) and the end of the configured frequency band was not reached (314), the BU 102 moves (316) to a next frequency and repeats the noise level determination (304). Additionally, if (306) the noise level is not below the predetermined threshold, the BU 102 moves (318) to a next frequency and repeats the noise level determination (304).

If (314) the end of the band was reached, before a sufficient number of low noise frequencies were identified, the subsequent transmission period 206 is optionally carried out with fewer uplink transmission channels. Alternatively, the subsequent transmission period 206 is partially or even entirely cancelled and is not used for uplink and/or downlink transmissions. In some embodiments of the invention, the decision on whether the subsequent transmission period 206 proceeds with fewer channels or is cancelled, depends on the number of low noise frequencies identified. In an exemplary embodiment of the invention, if at least three low noise frequencies are identified, the subsequent transmission period 206 is used, while where fewer low noise frequencies were identified, the subsequent transmission period is not used at all. Alternatively or additionally, the decision on whether to proceed with the subsequent transmission period depends on the estimated number of SUs 106 in the vicinity of the BU 102 and/or the specific application for which the transmissions are performed. When possible, SUs 106 will use other BUs 102 in their vicinity.

Optionally, BU 102 transmits (312) the message listing the uplink and downlink candidate channels, on the last (the N-th) frequency noted as having a low noise level. SUs 106 optionally move between frequencies together with BU 102 and listen to each frequency, in order to identify the message listing the uplink and downlink channels when it is transmitted. In some embodiments of the invention, SUs 106 also determine the noise level at each of the frequencies, in parallel to the determination by BU 102, in order to note which frequencies may be carrying signals from the BU 102 and which have too high a noise level and therefore would not be used by BU 102. It is noted, however, that SUs 106 may use a different noise level threshold, as they are not in the same location as BU 102 and do not receive precisely the same noise level.

In some embodiments of the invention, the frequency movements (316) and (318) are performed in predetermined steps. These embodiments are optionally used when BUs 102 are sufficiently distanced from each other, such that their transmissions do not interfere with each other. In an exemplary embodiment of the invention, the step between adjacent assessed frequencies is between about 25-50 KHz, although larger or smaller steps may be used, depending for example on the size of the entire frequency band, that network 100 is configured to use and/or on the extent of inter-frequency interference.

In other embodiments of the invention, however, when BU 102 is to move (316) to a next frequency after a suitable low noise frequency is identified, the low noise level is taken advantage of for notifying the SUs 106 on a non-predetermined movement step. Optionally, BU 102 selects a random frequency step and transmits the random frequency step to the SUs 106 on the low noise level frequency. It will be appreciated that using a random frequency step has various advantages, including, inter alia, avoiding interference between neighboring BUs 102 and making eavesdropping and/or cloning more difficult. In some embodiments of the invention, the random frequency steps are selected in advance for the N-1 low noise movements (316). Optionally, the random frequency steps are all transmitted by BU 102 each time a low noise frequency is identified, thus increasing the probability of receiving the random frequency steps by all the SUs 106. Optionally, the selection of the random frequency steps is performed by selecting random frequencies within the configured frequency band and calculating the frequency step from the frequencies and the knowledge of the current frequency. Alternatively to transmitting frequency steps, the BUs 102 transmit the absolute frequencies to be used to SUs 106.

The random frequency steps are optionally selected in a manner which ensures that at least a minimal number of frequencies will be able to be scanned. For example, BU 102 optionally requires a minimal frequency gap between each pair of adjacent random frequencies and the last random frequency and the end of the frequency band, to allow searching through a sufficient number of frequencies given the predetermined switching step between assessed frequencies. The sufficient number of frequencies optionally includes at least 8, at least 10 or even at least 15 frequencies. In some embodiments of the invention, if a low noise frequency was not found before reaching a next random frequency previously notified to SUs 106, BU 102 will switch to the next random frequency and will proceed the scanning from there. Alternatively, if a low noise frequency was not found before reaching a next random frequency previously notified to SUs 106, the next random frequency is ignored and the scanning proceeds in the predetermined steps until a low noise frequency is found. Optionally, if necessary, an additional random frequency will be generated by BU 102 to compensate for the random frequency for which a low noise frequency was not found. The BU 102 will optionally notify the SUs 106 regarding this frequency, the next time a low frequency is encountered.

Alternatively or additionally to taking advantage of the low noise level to transmit a message notifying the SUs 106 regarding the random movement step, BU 102 may use the frequency to transmit the fact that the frequency has a low noise level to the SUs 106, such that even if the transmission (312) of the uplink and downlink candidate channels is not received by an SU 106, the SU 106 can use one or more of the channels on which a message was received during assessment period 204.

Referring back to FIG. 2, the channel assessment period 204 optionally includes a plurality of specific frequency check periods 262, followed by a notification period 264 in which the BU 102 notifies the SUs 106 regarding which frequencies were selected. In some embodiments of the invention, a waiting period 266 occurs while BU 102 waits for information regarding the frequencies to be selected, from central controller 104, as discussed hereinbelow.

Each frequency check period 262 optionally has a predetermined duration selected to include a switching period 268, having sufficient time to allow tuning onto the frequency, a noise assessment period 270 and a transmission period 272 for cases in which a low noise level is identified and a message is transmitted from BU 102 to SUs 106.

Optionally, for simplicity, all frequency check periods 262 are the same length. Alternatively, BUs 102 may notify SUs 106 in messages transmitted on low noise frequencies regarding changes in the length of frequency check periods 262.

In some embodiments of the invention, channel assessment period 204 has a variable length that depends on the amount of time required in order to find a sufficient number of frequencies having low noise levels. Alternatively, channel assessment period 204 has a fixed duration. If a sufficient number of low noise frequencies are found before the end of channel assessment period 204, BU 102 waits until it transmits the list of suggested channels and/or SUs 106 wait until the time for the beginning of transmission period 206, before transmitting uplink data. In some embodiments of the invention, central controller 104 provides dynamic frequency allocations based on noise level information from BUs 102. Central controller 104 is optionally configured to expect to receive noise level information shortly after the end 274 of the last frequency check period 262. In some embodiments of the invention, if such information is not received from one or more BUs 102, the central controller 104 optionally queries the BU 102 for the information. Central controller 104 provides the BUs 102 with the dynamic frequency allocation a sufficient time before notification period 264, to allow the BUs 102 to prepare messages for transmission to the SUs 106.

In some embodiments of the invention, channel assessment period 204 has a minimal or average length, allowing BUs 102 to scan at least 10 or even at least 12 frequencies for each low noise frequency channel to be found. For example, if BU 102 is to search for nine low noise frequencies, channel assessment period 204 optionally has sufficient time for at least 50, at least 80 or even at least 100 frequencies. Optionally, switching to a frequency and assessing its noise level is assigned between about 30-40 seconds, although shorter or longer durations may be used depending on the time required to switch to a frequency and assess its noise level, while leaving time for the BU 102 to transmit a message if a low noise frequency is found.

Referring in detail to tuning (302) onto the first frequency of the configured frequency band, in some embodiments of the invention, the first frequency is the lowest frequency in the band, for example 902.025 MHz in the 902-928 MHz band. Alternatively, the first frequency may be some other arbitrary frequency. BUs 102 and SUs 106 are optionally configured to skip to the lower boundary of the band after scanning the frequency of the upper boundary of the band. Alternatively, BUs 102 and SUs 106 are configured to switch through the frequencies in some other order.

In order to prevent frequent occurrence of cases in which a plurality of adjacent BUs 102 identify the same low noise frequency and transmit a frequency identification message at the same time, in a manner which interferes, BUs 102 are optionally positioned sufficiently remote from each other such that their noise environment is expected to be different. Alternatively or additionally, SUs 106 are configured to tune onto a single BU 102 and avoid signals from other BUs 102, using any suitable method known in the art. For example, an FM capture method may be used to cause SUs 106 to relate to signals only from a single BU 102.

### Frequency Selection

In some embodiments of the invention in which the downlink transmissions are important for managing proper operation of the network, the channel with the lowest noise level is assigned for downlink transmissions. Alternatively, for example in cases in which the downlink transmissions are less important than the uplink content, the frequency with the highest noise level among the selected frequencies is used for downlink transmissions. Indeed, in some embodiments, the rules governing the selection of the downlink frequency may change dynamically and/or may be user configured, according to the specific application using the transmissions and/or the specific conditions of the BU 102 and/or the network 100.

While the frequencies used for uplink and downlink transmissions may be selected locally, in some embodiments of the invention, the selection is performed by central controller 104, which coordinates between the various BUs 102 in order to reduce interference between adjacent BUs 102. Optionally, after completing the frequency check periods 262, but before transmitting (312) the message listing the uplink and downlink channels in notification period 264, each BU 102 provides central controller 104 with a listing of the frequencies it identified and optionally their respective noise levels. Central controller 104 optionally selects a downlink frequency for each BU 102 in a manner such that adjacent BUs 102 do not use the same downlink frequency. In some embodiments of the invention, central controller 104 also selects the uplink channels to be used by each BU 102. Optionally, each BU 102 identifies N low noise frequencies, but uses only N-x uplink and downlink frequencies, leaving leeway for not using the same frequency in adjacent BUs 102. In one exemplary embodiment of the invention, N=9 low noise frequencies are identified, but only 7 uplink and one downlink frequencies are used. In another possible embodiment, 16 uplink channels are defined.

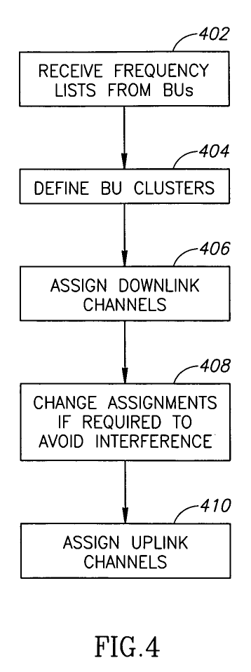

FIG. 4 is a flowchart of acts performed by central controller 104 in selecting communication frequencies, in accordance with one exemplary embodiment of the invention. Central controller 104 receives (402) low noise frequency lists, together with the noise levels measured, from each BU 102. In some embodiments of the invention, for example when BUs 102 may be mobile, central controller 104 also receives the locations of the BUs 102 as determined by their internal GPS 120. Alternatively, the locations of BUs 102 are preconfigured in central controller 104.

Controller 104 defines (404) clusters of BUs 102, such that BUs 102 whose transmissions may interfere with each other are included in the same cluster, however each specific BU 102 may be included in any number of clusters.

Each BU is assigned (406) the frequency that it identified as having a lowest noise level, as a downlink channel. For clusters including two or more BUs assigned the same downlink channel, the assignments for one or more of the BUs 102 are changed (408) to a slightly higher noise level, until none of the clusters have a plurality of BUs 102 assigned the same downlink channel.

From the remaining low noise level frequencies identified by each BU 102 and not assigned as a downlink channel, uplink channels are assigned (410) in a manner which prefers using lowest noise channels. Alternatively, preference is given to avoiding use of the same uplink frequency by a plurality of BUs 102 in a single cluster. Further alternatively, preference is given to assigning the same frequency to a plurality of BUs 102 in a single cluster for uplink transmission, such that the same uplink message will be received by a plurality of BUs 102.

In some embodiments of the invention, BUs 102 transmit an “end of frequency scanning” message to their SUs 106, after the scanning is completed, before their frequency assignment is received from central controller 104. The “end of frequency scanning” message serves as a notification to SUs 106 to stop the frequency movements and to wait for the message listing the uplink and downlink channels.

In scenarios where a SU 106 does not receive the message listing the uplink and downlink channels, the SU 106 optionally refrains from transmitting in the subsequent transmission period 206. Alternatively, the SU 106 uses the information regarding the frequencies that had low noise levels from the channel assessment period 204, for uplink transmissions. Optionally, before transmitting, the SU 106 that did not receive the message listing the uplink and downlink channels listens to the channel to verify that it is actually intended for uplink transmissions and not for downlink transmissions. Optionally, the SU 106 notifies the BU 102 in the message it transmits that the channel allocation message was not properly received, so that the BU 102 knows that any downlink transmissions in the current transmission period were not received or should not be transmitted until the next transmission period. The notification from the SU 106 optionally notifies how many low noise frequencies it identified, so as to provide central controller 104 with information useful in assessing the quality of transmissions over the network. Optionally, a notification that the channel listing message was not received, is transmitted close to the beginning of the transmission period 206. Alternatively, such notification is transmitted according to the normal slot selection, to avoid possible collisions when a large number of SUs 106 did not receive the channel allocation message.

### Alternative Downlink Selection

Alternatively or additionally to selecting a broadcast downlink channel together with the uplink channels, each of SUs 106 selects a downlink channel for unicast transmissions from the BU 102 to the SU 106. Optionally, as mentioned above, the SUs 106 determine the level of noise on the scanned frequencies, in parallel to the determination by the BU 102. The SUs 106 note one or more frequencies having a low noise level and at the end of assessment period 204 select a frequency on which to receive unicast messages from the BU 102. During transmission period 206, the SU 106 transmits a message to the BU 102 including indication of the selected unicast frequency. The message may include in addition to the selected unicast frequency, other information, such as application data, or may be dedicated for transmission of the selected unicast frequency. After transmitting the message, or possibly even before the transmission, the SU 106 sets its receiver to listen to the selected unicast channel.

In some embodiments of the invention, during the frequency assessment period 204, SU 106 notes a plurality of low noise frequencies. The frequency selected to serve as the unicast downlink channel is optionally required not to be any of the channels selected by BU 102 for uplink transmission. In some embodiments of the invention, the frequency selected to serve as the unicast downlink channel is the frequency with the lowest noise level that was not selected by the BU 102.

If the BU 102 has data to be transmitted to the SU 106, upon receiving the message indicating the selected unicast frequency, the BU 102 sets its transmitter to the selected frequency and transmits the data to the SU 106. It is noted that if the message indicating the selected unicast channel is transmitted toward the end of transmission period 206, BU 102 may not have sufficient time to transmit the data destined to the SU 106, in the current sub-cycle 202. Optionally, therefore, the selection of a slot for transmission of the message including an indication of the unicast channel to the BU 102 is performed randomly, so that the chances that a SU will repeatedly transmit its messages at the end of cycles 102 is negligible. Alternatively or additionally, the slots 226 at the end of transmission period 206 are used primarily for transmission of additional messages by SUs 106, and first messages of the current sub-cycle 202 are not transmitted in the last few slots 226 of a sub-cycle 202. In some embodiments of the invention, different SUs 106 have different rates at which they receive unicast messages from BU 102. The SUs 106 having a high rate of receiving download messages and/or require fast reception of download messages, optionally select a slot 226 from a range not including the last few slots of the cycle. Other SUs 106 optionally select a slot for their message from the entire range of slots 226.

In some embodiments of the invention, only a unicast or only a broadcast downlink channel is used. For example, when only a unicast channel is used, broadcast messages may be transmitted during assessment period 204. Alternatively, SUs 106 have two receivers for receiving downlink messages during transmission period 206. One of the receivers is used in receiving unicast messages and one in receiving broadcast and/or multicast messages. Alternatively or additionally, in the beginning of transmission period 206, SUs 106 listen to the broadcast channel and later on in the transmission period 206 they listen to their unicast channel. Further alternatively or additionally, SUs 106 are configured to tune onto the broadcast downlink channel for some sub-cycles 202 and to tune onto their unicast downlink channel in other sub-cycles 202. In some embodiments of the invention, in accordance with this alternative, for cycles in which the SU 106 tunes onto the broadcast downlink channel, a unicast downlink channel is not selected at all. In other embodiments of the invention, SUs 106 tune onto the broadcast channel and BUs 102 instruct them to move to their unicast channel when necessary, on the broadcast channel. Alternatively, some or all of SUs 106 tune onto their unicast channel and BUs 102 instruct them to move to the broadcast channel when necessary, on the unicast channel.

Optionally, SUs 106 acknowledge reception of downlink messages in their next uplink message, possibly in the next sub-cycle 202. The BU 102 optionally continues to transmit the downlink message in each sub-cycle 202, until an acknowledgement is received.

### Interaction With a Plurality of Base Units

In some embodiments of the invention, each SU is configured to operate with a predetermined BU 102. Such embodiments are generally suitable for stationary SUs 106. In other embodiments of the invention, at the beginning of each sub-cycle 202, each SU 106 selects a single BU 102 to tune onto, such as the first BU 102 from which transmissions are received. Alternatively, the SU 106 selects a specific BU 102 based on signal strength and/or the identities of the BUs 102 used in previous sub-cycles 202, for example.

In some embodiments of the invention, SUs 106 include a plurality of transceivers and follow the channel assessment of a plurality of BUs 102, when signals are received from a plurality of BUs 102. Optionally, in such configurations, the SU 106 receives the channel listing messages from the plurality of BUs 102 and selects one of the BUs 102 based on its signal strength and/or other attributes of the BUs 102.

When a BU 102 is required to service more SUs 106 than it can handle, the geographical area previously serviced by a single BU 102 is divided between a plurality of BUS 102 in a manner which minimizes interference between the BUs 102. Alternatively or additionally, a plurality of BUs 102 are installed in a same location to service an at least partially overlapping geographical area. In this alternative, the BUs 102 are optionally configured to use different frequency bands and different SUs 102 are configured to operate with different BUs 102. In other embodiments of the invention, the BUs 102 cooperate at the beginning of each channel assessment period 204 to distribute between them the SUs 106 they service. When a first low noise frequency is identified, one of the BUs 102 transmits a frequency skipping message in a low amplitude, such that only some of the SUs 106 in the serviced geographical region receive the message and follow the frequencies of that BU. The remaining SUs 106 continue in fixed step frequency switching with a second BU 102. At the end of the sub-cycle 202, the number of SUs 106 operating with each of the BUs 102 is determined from their uplink transmissions and accordingly the amplitude of transmission of the first BU is adjusted to achieve a desired distribution of SUs 106 between the BUs 102. It is noted that this method is not limited to only two BUs 102 but rather may be used with three or more BUs, each utilizing a higher amplitude at a later time within assessment period 204.

### Assessment Period Alternatives

Alternatively to transmitting the message listing the uplink and downlink channels on a frequency identified during the assessment period, the message may be transmitted on a predetermined frequency, such as a dedicated frequency having a low noise level. In accordance with this alternative, SUs 106 are not required to move between the scanned frequencies along with their BU 102 and thus they have lower power utilization, which is especially useful for battery powered SUs 106.

Instead of identifying the first N frequencies below a predetermined threshold, BU 102 may identify the N frequencies having the lowest noise level among the frequencies scanned. Optionally, BU 102 scans a plurality of frequencies and manages a list of the N lowest noise frequencies encountered thus far. In some embodiments of the invention, in searching for the frequencies having the lowest noise levels, only frequencies having a noise level below a predetermined threshold are considered.

### Transmissions

Referring in more detail to transmission period 206, in some embodiments of the invention, the transmission period 206 is divided into a plurality of time slots 226 on the plurality of assigned uplink channels, and each SU 106 which needs to transmit information selects one or more time slots 226 for its transmissions. Optionally, the time slots 226 used for transmission are randomly selected by the SUs 106, to minimize collisions. Alternatively, for example in an area in which SUs 106 are entirely or mainly stationary, each SU 106 is configured with one or more time slots 226 it is to use. Further alternatively or additionally, based on information from previous transmission cycles 230, BU 102 estimates the number and identities of the SUs 106 in its vicinity and allocates a portion of the time slots 226 to these SUs 106. The remaining slots 226 are optionally used by other SUs 106, which were not allocated slots, or not allocated sufficient slots.

Alternatively to completely random selection of time slots, SUs 106 may take other considerations into account in selecting the time slots for transmissions. In some embodiments of the invention, each SU 106 determines the noise levels of the various frequencies during the channel assessment period 204 and makes note of the noise level of frequencies determined by BU 102 to serve as uplink channels. In selecting which of the uplink channels is to be used for transmission of messages, SUs 106 optionally give preference to channels determined by them to have lower noise levels than others.

In some embodiments of the invention, SUs 106 are configured to identify collisions and perform retransmissions using any method known in the art, such as ALOHA. Alternatively, for simplicity, no retransmission scheme is used, for example in applications wherein missing a single transmission is not crucial. Optionally, messages are transmitted with redundancy, for example with forward error correction (FEC) encoding or are merely transmitted twice, on same or different uplink channels.

In some embodiments of the invention, some or all of SUs 106 implement a “listen before talk” procedure, in which SUs 106 determine that the channel is not used by another SU 106 before transmitting, to reduce the percentage of collisions.

The uplink transmissions may use other known suitable time domain multiplexing (TDM) methods for sharing the bandwidth efficiently. For example, in one alternative embodiment, transmission period 206 is divided into a bandwidth requesting stage in which SUs 106 request bandwidth and a transmission stage in which SUs 106 transmit data in slots allocated on the downlink channel responsive to the requests.

The timing of the time slots 226 is optionally governed by a shared clock signal, such as the GPS time signal.

The statistical utilization of the uplink channels is optionally selected as a trade-off between maximizing bandwidth usage and preventing occurrence of many collisions. In some embodiments of the invention, a statistical utilization of about 10% of slots 226 is aimed for. For time critical applications, a lower statistical utilization rate, optionally lower than 5% may be aimed for, to make the chances of a collision very low. The adjustment of the statistical utilization is optionally achieved by selecting the number of selected uplink frequencies and/or the number of BUs employed.

In an exemplary embodiment of the invention, a BU 102 selects 16 uplink channels in each sub-cycle 202 and has about 600 slots 226 in each cycle 230. The BU 102 is optionally set to service about 1000 SUs 106 which each requires transmission of one message in each cycle 230.

### Downlink Transmissions

In some embodiments, the downlink channel is reserved for control signals only, such as acknowledgements, bandwidth allocations and operation instructions. In some embodiments of the invention, the downlink channel is used for changing configured parameters. Alternatively, the downlink channel may also be used for data transmission or even mainly for data transmission. For example, the downlink channel may be used for broadcast, multicast and/or unicast messages, such as short text messages in accordance with the SMS service, email services or a similar service.

### Management

Central controller 104 is optionally configured to keep track of the messages transmitted to SUs 106 and received therefrom, for billing purposes as well as to ensure proper quality of service to SUs 106. In some embodiments of the invention, central controller 104 determines the number of SUs 106 serviced by each BU 102 and identifies overloaded BUs 102. Optionally, central controller 104 identifies SUs 106 that can be serviced by one or more BUs other than the overloaded BU 102, and sends those SUs 106 instructions to tune to a different BU 102, on the downlink channel of the BU they are currently tuned to. Alternatively or additionally, central controller 104 instructs the overloaded BU 102 to lower its transmission amplitude, in order to reduce the number of SUs 106 it services.

### Security Application

In some embodiments of the invention, network 100 is used in an application requiring continuous communication between SUs 106 and central controller 104, such as a security application. Optionally, each SU 106 is required to transmit a still-alive message every predetermined notification period 230. The notification periods 230 may be the same length as a single sub-cycle 202 or may have a different length, preferably the length of an integer number of sub-cycles 202.

Within each notification period 230, each SU 106 optionally randomly selects a time slot 226 and transmits a still-alive message, including its ID and status, to a BU 102. The length of notification period 230 is optionally selected according to the number of SUs 206 being serviced, such that the channel is efficiently utilized. Alternatively, the length of notification period 230 is application specific. For example, for a security application, the length of notification period 226 is optionally sufficiently short to provide quick notification to warn if SU 106 has been tampered with. In one exemplary embodiment of the invention, notification period 230 is shorter than 5 minutes, shorter than 2 minutes or even shorter than one minute. In some embodiments of the invention, the still-alive messages are transmitted in irregular intervals. For example, the transmission time of each still-alive message may be selected randomly, for example from a range between 20-100 seconds after the previous still-alive message was transmitted. Alternatively, the still-alive messages are transmitted in notification periods with lengths that vary according to a predetermined pattern.

In embodiments in which notification period 230 includes more than one sub-cycle 202, SUs 106 may select in advance in which sub-cycle 202 they will transmit their still-alive notification and refrain from participating in the channel assessment in the other sub-cycles 202 of the notification period 230. Alternatively, SUs 106 participate in the channel assessment in all sub-cycles 202 even if they do not intend to transmit in a specific sub-cycle 202, to allow transmission in case an emergency occurs.

In some embodiments of the invention, the number of BUs 102 employed in network 100 is a function of the number of serviced SUs 106 and the lengths of notification periods 230.

Optionally, if a still-alive message is not received from a SU 106, central controller 104 assesses the chances that the missing message is due to a security problem and accordingly determines whether to generate a “suspected tamper” notification. Optionally, the assessment is based on the chances a message from the SU 106 was lost due to a slot collision, as determined from the number of slots in which transmission collisions occurred in the sub-network of the BU 102 servicing the SU 106. Alternatively or additionally, the estimation is performed based on the number of low noise frequencies that were identified. For example, if the low noise frequencies had relatively high noise levels and/or fewer than usual low noise frequencies were identified, central controller 104 optionally assigns a lower likelihood to the missing message being caused by a security problem. The suspected tamper notification may further depend on the importance of the location of the SU 106 and/or on the number of consecutive or non-consecutive expected still-alive notifications that were not received.

If an actual alarm occurs at a site of an SU 106, the SU 106 optionally immediately transmits an alarm message in a first available slot 226, and the alarm message is forwarded by the BU 102 immediately, to central controller 104.

### Other Applications

Network 100 may be used for many communication services, including security tasks (e.g., residential, business or other premise protection), industrial monitoring, energy management, traffic and parking reporting and distribution of advertisements, to list just a few. For example, SUs 106 may provide readings of various types of sensors in a wide range of applications. In some embodiments of the invention, network 100 is used for monitoring vehicles or other objects. In other embodiments, SUs 106 provide safety sensor readings, such as temperature readings in green-houses or animal homes, leakage warnings from oil pipes or off-shore rigs and railroad junction warnings, to list a few such examples.

In the above description, network 100 was described primarily for uplink transmission. In other embodiments of the invention, however, network 100 may be used primarily for downlink transmissions or for both uplink and downlink transmissions. For example, most of the identified low noise frequencies may be allocated for downlink transmission, rather than for uplink transmission. In some embodiments of the invention, BU 102 selects fewer frequencies for uplink transmission, and uses its transceivers primarily for downlink transmission on the selected unicast channels of the SUs 106. Optionally, to allow fast conveying of the selected unicast channels, BU 102 selects a large number of uplink channels. These uplink channels are used during a first portion of transmission period 206 to convey the selected downlink unicast channels. During a second portion of transmission period 206, most or even all the uplink channels are not used anymore, and BU 102 uses its transceivers for downlink transmissions.

### Ending Remarks

It will be appreciated that the above described description of methods and apparatus are to be interpreted as including apparatus for carrying out the methods and methods of using the apparatus. The present invention has been described using non-limiting detailed descriptions of embodiments thereof that are provided by way of example and are not intended to limit the scope of the invention. Many specific variations of implementation details may be used.

It should be understood that features and/or steps described with respect to one embodiment may sometimes be used with other embodiments and that not all embodiments of the invention have all of the features and/or steps shown in a particular figure or described with respect to one of the specific embodiments.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Variations of embodiments described will occur to persons of the art. Therefore, the scope of the invention is limited only by the elements and limitations as used in the claims, wherein the terms “comprise,” “include,” “have” and their conjugates, shall mean, when used in the claims, “including but not necessarily limited to.”

1. A method of wireless transmission by a base unit, comprising:
(I) scanning a plurality of frequencies to determine frequencies having low noise levels, by the base unit;
(II) selecting, by the base unit, uplink channels, responsive to the determined frequencies having low noise levels;
(III) transmitting to subscriber units, by the base unit, a message indicating the selected uplink channels;
(IV) tuning the base unit to receive uplink messages on the selected uplink channels; and
(V) repeating (I)-(IV) for a plurality of transmission cycles.

2. A method according to claim 1, wherein scanning the plurality of frequencies comprises scanning a group of frequencies including at least one frequency selected randomly.

3. A method according to claim 2, wherein scanning the plurality of frequencies comprises sequentially scanning frequencies at predetermined intervals until a frequency with a low noise level is identified, and skipping to a randomly selected frequency when the frequency with a low noise level is identified.

4. A method according to claim 1, wherein scanning the plurality of frequencies comprises scanning until a predetermined number of low noise frequencies are identified.

5. A method according to claim 1, wherein selecting the uplink channels is performed at least partially responsive to instructions from a central controller.

6. A method according to claim 1, wherein selecting the uplink channels comprises selecting a predetermined number of lowest noise frequencies.

7. A method according to claim 1, wherein selecting the uplink channels comprises selecting a predetermined number of frequencies having a noise level below a predetermined threshold.

8. A method according to claim 1, comprising identifying during the scanning candidate frequencies and transmitting a message on at least one of the candidate frequencies during the scanning.

9. A method according to claim 8, wherein the transmitted message includes an indication of a next frequency to be scanned.

10. A method according to claim 1, wherein the repeating is performed at a configured period cycle and wherein the tuning to receive uplink messages occupies less than 80% of the period of the cycle.

11. A method according to claim 1, wherein the repeating is performed at least every five minutes.

12. A method according to claim 11, wherein the repeating is performed at least every minute.

13. A method according to claim 1, wherein scanning the plurality of frequencies comprises scanning frequencies in a non-licensed frequency band.

14. A method of wireless transmission by a subscriber unit, comprising:
(I) scanning a plurality of frequencies to determine their noise levels, by a subscriber unit;
(II) selecting a frequency with a low noise level for receiving transmissions;
(III) transmitting a message indicating the selected frequency, from the subscriber unit to a base unit;
(IV) tuning onto the selected frequency to receive messages transmitted from the base unit; and
(V) repeating (I)-(IV) for a plurality of transmission cycles every hour.

15. A method according to claim 14, wherein scanning the plurality of frequencies comprises skipping between at least some of the frequencies by a predetermined frequency jump.

16. A method according to claim 14, wherein scanning the plurality of frequencies comprises skipping to at least one of the scanned frequencies according to an instruction received from the base station.

17. A method according to claim 14, wherein selecting the frequency comprises receiving a message from the base unit indicating frequencies for uplink transmissions to the base unit and selecting a frequency not included in the frequencies for uplink transmission, for receiving transmissions.

18. A method according to claim 17, wherein transmitting the message indicating the selected frequency on one of the frequencies fro uplink transmission.

19. A method according to claim 14, wherein repeating (I)-(IV) for a plurality of transmission cycles every hour comprises repeating (I)-(IV) at least every two minutes.

20. A method according to claim 19, wherein repeating (I)-(IV) for a plurality of transmission cycles every hour comprises repeating (I)-(IV) at least every 30 seconds.

21. A method according to claim 19, comprising transmitting a still-alive message from the subscriber unit to the base station at least every two minutes.

22. A method of allocating frequencies in a base station network, comprising:
receiving lists of low noise frequencies, by a central controller, from a plurality of base stations;
assigning frequencies to be used by each of the base stations by the central controller, responsive to the received lists, in a manner which minimizes interference between the base stations; and
repeating the receiving of lists and assigning frequencies at least every 10 minutes.

23. A method according to claim 22, wherein repeating the receiving of lists and assigning of frequencies is performed at least every minute.

24. A base unit, comprising:
a plurality of transceivers; and
a controller configured to periodically, a plurality of times an hour, scan a plurality of frequencies to determine their noise levels, select responsive to the scanning a plurality of frequencies for uplink transmissions, transmit a message listing the selected frequencies through one of the transceivers and set for each of the selected frequencies one of the transceivers to receive messages on the selected frequency, until a next scan is performed.

25. A base unit according to claim 24, wherein the controller is configured to randomly select at least two of the frequencies scanned.

26. A base unit according to claim 24, wherein the controller is configured to select at least two of the frequencies scanned by progressing a predetermined frequency step from a previously scanned frequency.

27. A method of wireless transmission, comprising:
providing a plurality of base stations configured to service subscriber units in their vicinity;
configuring the base stations to communicate with the subscriber units over an unlicensed frequency band;
receiving communications from subscriber units by the plurality of base stations over the unlicensed frequency band; and
transferring the received communication by the plurality of base stations to a central unit.

28. A method according to claim 27, wherein the base stations are configured to periodically select specific low frequencies within the band on which the communications are received.

29. A method according to claim 27, wherein the plurality of base stations include at least 50 base stations.

30. A method according to claim 27, wherein providing the base stations comprises providing at least one base station having an antenna longer than 100 meters.

31. A method of wireless transmission, comprising:
(I) selecting one or more frequencies, at least partially randomly;
(II) transmitting a list of the selected frequencies;
(III) receiving transmissions on the one or more selected frequencies; and
(IV) repeating (I)-(III) at least every five minutes.

32. A method according to claim 31, wherein selecting the one or more frequencies comprises scanning a plurality of frequencies and selecting frequencies having a low noise level.

33. A method according to claim 32, wherein scanning a plurality of frequencies comprises scanning a plurality of frequencies at predetermined frequency steps from each other until a low noise frequency is found and then skipping to a randomly selected frequency.

34. A method according to claim 31, wherein transmitting the list of the selected frequencies comprises transmitting on a frequency determined as having a low noise level.
